(19) United States
(12) Patent Application Publication
(10) Pub. No.: US 2024/0196914 A1
(43) Pub. Date: Jun. 20, 2024

(54) Cold Smoke System

(71) Applicant: W.C. BRADLEY CO., Columbus, GA (US)

(72) Inventors: JAMES D. KRING, Opelika, AL (US); RAMIN KHOSRAVI RAHMANI, Columbus, GA (US); Thomas Kessler, Columbus, GA (US); DANIEL DEMARS, Columbus, GA (US); Dylan Horton, Daphne, AL (US); Seth Sawyer, Columbus, GA (US)

(21) Appl. No.: 18/543,818

(22) Filed: Dec. 18, 2023

Related U.S. Application Data
(60) Provisional application No. 63/433,662, filed on Dec. 19, 2022.

(51) Int. Cl. A23B 4/052

(52) U.S. Cl. CPC A23B 4/052

(57) ABSTRACT

A cold smoke system having a smoke chamber member mounted to a frame. The chamber member defines a receptacle for receiving a combustible fuel source for producing smoke. An ignitor ignites the fuel source. A fan moves air and smoke through the receptacle and into, e.g., a grill cooking chamber. A floor of the chamber member defines an ignitor slot for receiving the ignitor and defines ash openings for allowing to fall out of the receptacle into a tray. The smoke chamber member may be rotationally mounted to the frame. The receptacle has an increasing cross-sectional area in a direction of air flow through the receptacle. A fuel container containing the fuel source is received in the receptacle of the chamber member. The fuel container may have a shape that corresponds to the shape of the receptacle and may be constructed of the same material as the fuel source.

### CROSS-REFERENCE TO RELATED CASES

This application claims the benefit of U.S. provisional patent application Ser. No. 63/433,662, filed on Dec. 19, 2022, and incorporates such provisional application by reference into this disclosure as if fully set out at this point.

### FIELD OF THE INVENTION

This disclosure relates to cooking appliance in general and, more specifically, to a system for smoking foods.

### BACKGROUND OF THE INVENTION

Currently, smoke systems generate smoke when a user ignites wood shavings or chips placed in a fire cup or chamber. Air is forced through the fire cup containing the ignited or smoldering shavings or chips, and is then directed through tubing to a desired location.

Current cold smoke systems have several limitations. First, the user is required to manually pour or move the wood shavings or chips to the fire cup or chamber, which typically results in the overfilling and/or spillage of the shavings or chips. Second, the user is required to manually light the wood shavings/chips to start the smoldering process. Third, the fan speed and flow rate are typically fixed to a certain value with no variation through the course of the smoking process. Fourth, the fire cup/chamber typically are in linear format, whether oriented vertically or horizontally. The cross-section of the fire cup or chamber, and thus the volume of the wood shavings or chips, does not change. This results in the need for higher air flow at the beginning of the smoke, which produces poor performance toward the end of the smoking. The length of the fuel chamber may also be shortened, resulting in a shorter overall smoking period.

What is needed is a system and method for addressing the above and related issues.

### SUMMARY OF THE INVENTION

The invention disclosed herein, in one aspect thereof, is a self-igniting, low temperature smoke system. The system may be self-igniting in that the ignition components are built in to the system rather than requiring a separate device or step to be executed by the user. The system may be a “low temperature” or “cold smoke” system in that cooking levels of heat are not necessarily generated by the system. Combustion may be used to generate smoke, which is the primary method of preparing the food. This does not mean, however, that the systems of the present disclosure cannot be employed in a cooking grill that also uses high temperature in a loading position cook foods.

Systems of the present disclosure may utilize a dynamically controlled air flow rate provided by one or more fans, or other air movement implements. Fuels may comprise wood chips, wood shavings, wood pellets, or other combustible products known to the art. The fuel may be contained within a container having a particular shape and other characteristics described further below. The container may be considered a pod, pouch, cup, or other container capable of containing the smoldering fuel. In addition to fuel, the container may contain additional enhancements or alternative flavors (such as spices, ground coffee, crushed charcoal, etc.).

The systems of the present disclosure allow a user to use a prepackaged pod/pouch/container of combustible material, such as wood flour, wood shavings/chips that are ignited by the smoke system. The variable speed fan allows control over the rate and intensity of the smoke generation. The non-uniform cross-section pod/pouch/container allows optimal fuel consumption throughout the entire process.

In greater detail, in one embodiment, the system of the present disclosure is a cold smoke system comprising a frame and a smoke chamber member mounted to the frame. The smoke chamber member defines a receptacle for receiving a fuel source that is suitable for combustion to produce smoke. An ignitor is provided for igniting the fuel source when the smoke chamber member is in a closed/operational position, wherein the ignitor includes a heat source. A fan is mounted on the frame for moving air through the receptacle and for delivering smoke, e.g., to an output member for directing smoke into a cooking chamber of a grill.

The receptacle may be defined, in part, by a roof member and a floor member, wherein the floor member defines an ignitor slot for receiving the ignitor when the smoke chamber member is in the closed/operational position.

The smoke chamber member may define air flow openings for facilitating air flow through the receptacle. The floor member may define ash openings for allowing combustion by-products from the fuel source to fall out of the receptacle.

The smoke chamber member is preferably moveable with respect to the frame to an open/loading position and to the closed/operational position. In one embodiment, the smoke chamber member is rotationally mounted to the frame. In one embodiment, the smoke chamber member is movable by a magnetic push-pull latch system via a magnetic latch.

The receptacle preferably defines a variable cross-section having an increasing cross-sectional area in a direction of air flow through the receptacle. A fuel container is preferably provided for locating in the receptacle of the smoke chamber member, the fuel container containing the fuel source. The fuel container may have a shape that corresponds to the shape of the receptacle. The fuel container may be constructed of the same material as the fuel source.

An ash tray is preferably located beneath the receptacle of the smoke chamber member when the smoke chamber member is in the closed/operational position.

A safety mechanism may be provided for selectively shutting off the fan and/or the ignitor for preventing accidental heat or smoke leakage.

### BRIEF DESCRIPTION OF THE DRAWINGS

FIG. 1A is a lower oblique perspective view of a fuel container with a non-uniform cross section according to aspects of the present disclosure.

FIG. 1B is a bottom view of the fuel container of FIG. 1A.

FIG. 1C is an end view of the fuel container of FIG. 1A.

FIG. 2 is a lower oblique perspective view of a smoke chamber according to the present disclosure, with direct ignitor access and accommodation for a fuel container with a non-uniform cross section.

FIG. 3 is a lower plan view of the smoke chamber of FIG. 2.

FIG. 4 is elevation view of the smoke chamber of FIG. 2.

FIG. 5 is an oblique perspective view of a cold smoke generation system according to aspects of the present disclosure.

FIG. 6 is a side cross sectional view of a cold smoke generation system of FIG. 5 according to aspects of the present disclosure, without a magnetic latch.

FIG. 7 is a side cross sectional view of a cold smoke system of FIG. 5 according to aspects of the present disclosure, with a magnetic latch.

FIG. 8 is a front perspective, partially transparent view of a cooking device incorporating a cold smoke system of the present disclosure having a single zone smoke output.

FIG. 9 is an overhead, partially transparent view of the cooking device of FIG. 8.

FIG. 10 is a front perspective, partially transparent view of a cooking device incorporating a cold smoke system of the present disclosure having a dual zone smoke output.

FIG. 11 is an overhead, partially transparent view of the cooking device of FIG. 10.

FIG. 12 is an elevation view of a round fuel container.

FIG. 13A is a perspective view of an embodiment of a cold generating system of the invention showing the fuel container of FIG. 12 uninstalled.

FIG. 13B is a perspective view of the cold smoke generating system of FIG. 13A showing the fuel container of FIG. 12 installed.

FIG. 14 is an elevational view of the embodiment of a cold smoke generating system of FIGS. 13A and 13B showing the smoke chamber member in an open/loading position.

FIG. 15 is an elevational view of the embodiment of a cold smoke generating system of FIGS. 13A and 13 shown in a closed/operational position with an air path and a smoke path illustrated.

### DETAILED DESCRIPTION OF THE PREFERRED EMBODIMENTS

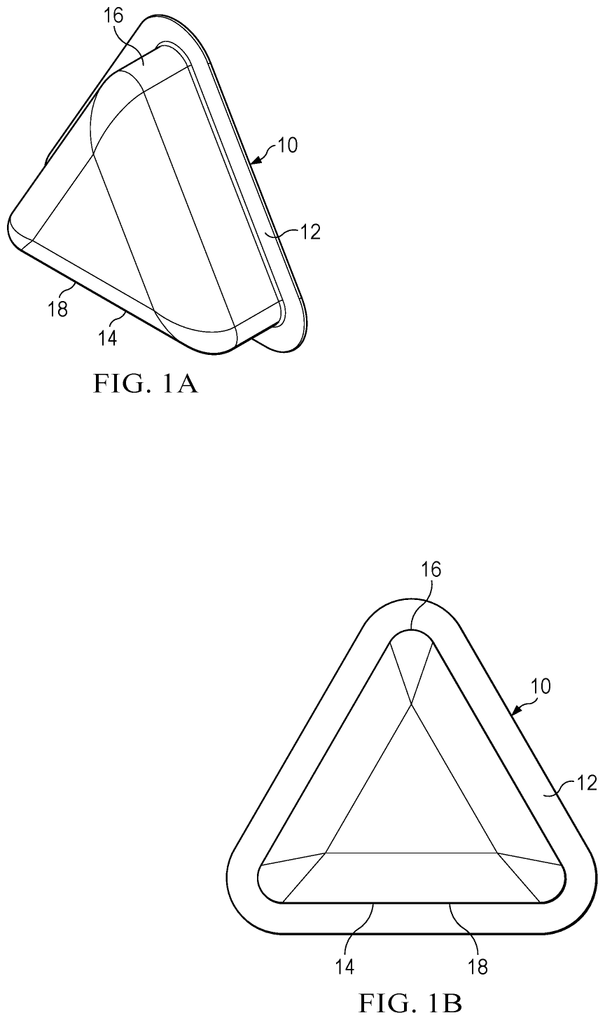

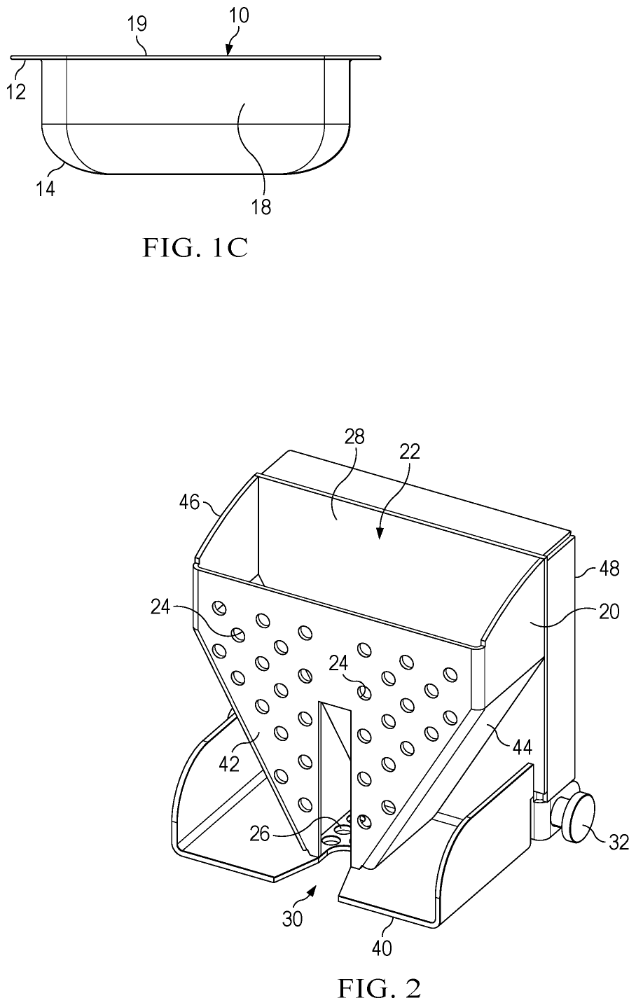

Referring now to FIG. 1A, a lower oblique perspective view of a fuel container 10 with a non-uniform cross section according to aspects of the present disclosure is shown. FIG. 1B is a bottom view of the fuel container 10 of FIG. 1A; and FIG. 1C is and end view of the fuel container 10 of FIG. 1A. Fuel container 10 may comprise a body or cup 14 possibly having an upper lip 12. The body 14 and/or cup may be formed from a food-safe consumable material. In other embodiments, body 14 may be a refillable component that is reused. The body 14 may define an interior space that contains fuel. A top cover 19 may seal or retain the fuel within the container 10 for transport and loading into the smoking systems of the present disclosure. The top cover 19 may be made from food safe material and/or combustible material. In some embodiments, the entire fuel container 10 is made from a fuel source suitable for combustion to produce smoke. In some embodiments, the fuel source comprising the fuel container 10 is the same fuel contained within the body 14.

The overall geometric design of the fuel container 10 (and the corresponding combustion chamber described below) may be that of a non-uniform cross section such that the container 10 is narrower or smaller in cross sectional area at a first end 16 but larger toward a second end 18. Air flow through the fuel and/or container 10 may be from the first end 16 to the second end 18. Thus, the geometry of the container 10 may allow for a higher rate of fuel being exposed to the smoldering heat as the process penetrates through the container 10. Such a design, which possesses an increase in the cross-section in the direction of the smoldering flow, will provide strong and long-lasting steady smoke flowing out of the device through the entire time of the operation. As shown, fuel container 10 is roughly triangular in shape such that the increase in cross section is approximately linear. However, other geometries of increasing cross section may be suitable as well.

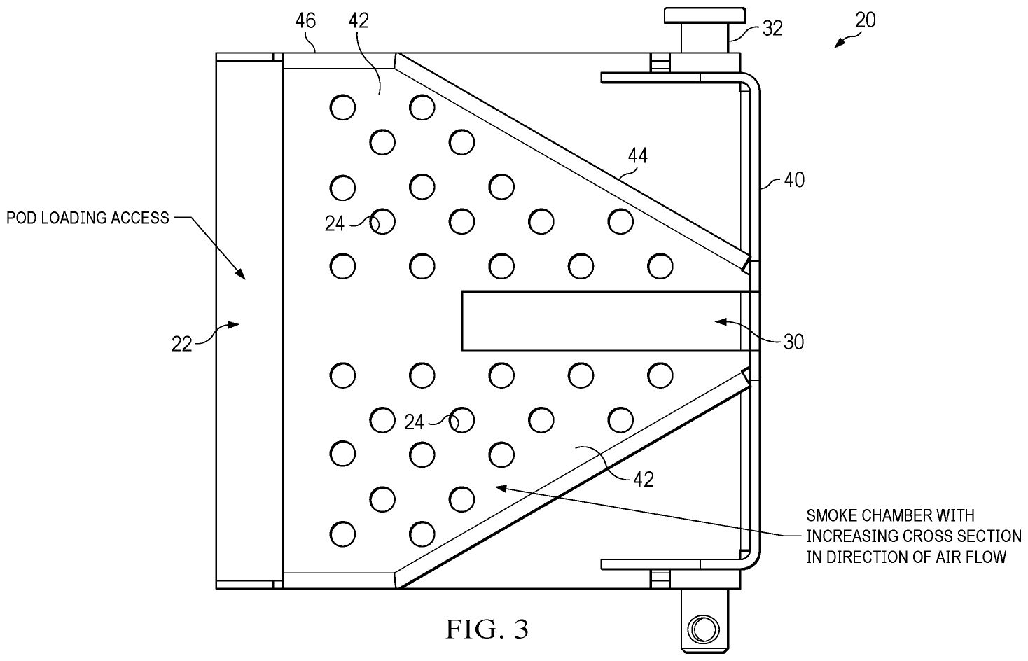

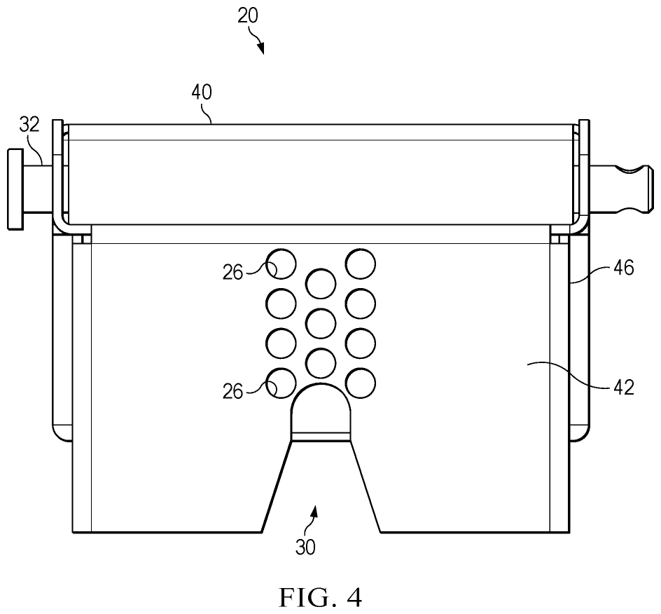

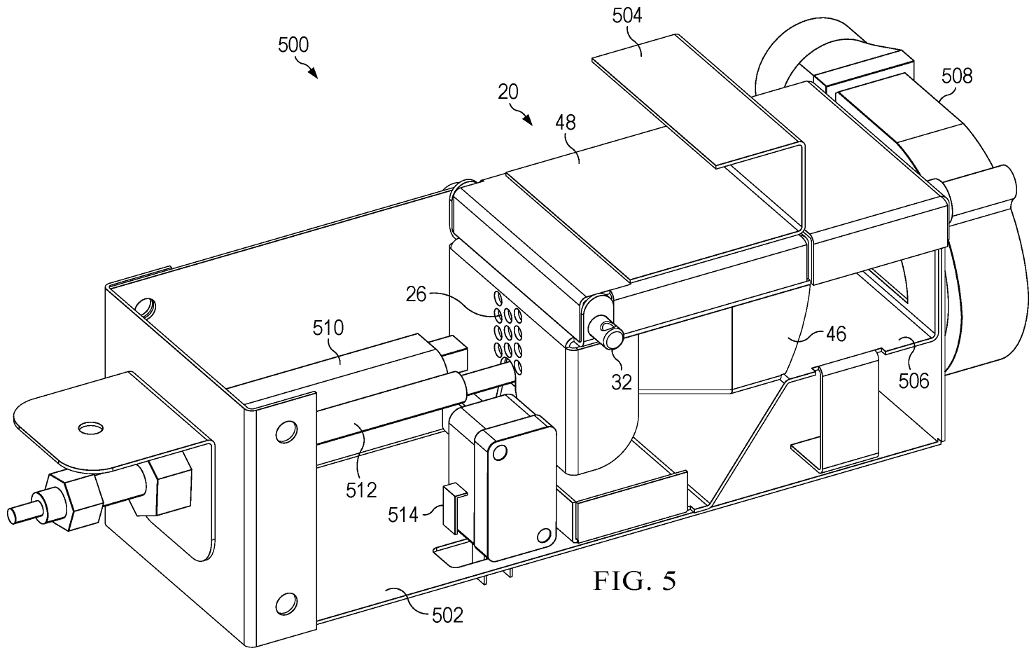

Referring now to FIG. 2 is a lower oblique perspective view of a smoke chamber member 20 according to the present disclosure is shown. FIG. 3 is a lower plan view of the smoke chamber member 20 of FIG. 2. FIG. 4 is a lower perspective of the smoke chamber member 20 of FIG. 2. Smoke chamber member 20 defines a receptacle 22 that may correspond to the shape of fuel container 10 and have an increasing cross-sectional area. Receptacle 22 may be defined by a flat roof 48, a lower flat floor 42, straight sidewall segments 46, and tapering sidewall segments 44. The tapering sidewall segments 44 aid to conform the receptacle 22 to the generally triangular shape of a fuel container such as fuel container 10 discussed above. Where the geometry of the fuel container 10 differs, the shape of receptacle 22 may differ as well.

A loading port 28 allows for insertion and removal of the fuel container 10 into receptacle 22. Opposite the loading port 28 may be a rear wall 40, which may extend laterally beyond the tapered end of the sidewall segments 44, for reasons discussed further below. Between the sidewall segments 44, where they meet the rear wall 40, one or more air flow openings 26 may be defined in the rear wall 40. In operation, combustion air flows into receptacle 22 through air flow openings 26. Direct ignitor access to a fuel container 10 in the smoke chamber receptacle 22 may be provided by an ignitor slot 30, which may be defined in lower flat floor 42 and/or rear wall 40. Ash openings or slots 24 may be defined in the floor 42 to allow ash and other non-gas combustion products to fall out of the combustion chamber receptacle 22.

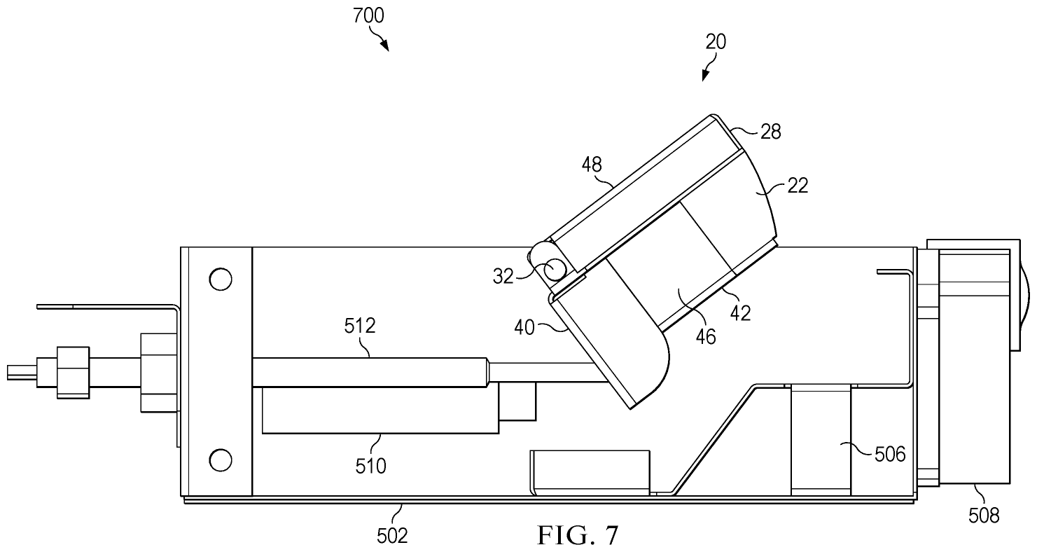

To accommodate loading and reloading of the smoke chamber receptacle 22, the smoke chamber member 20 may rotate about an axis 32, which may be equipped with an axle or other rotatable fastening mechanism. In other embodiments, smoke chamber member 20 may be movable in other ways such as sliding vertically or horizontally. This movement may be assisted by a mechanical or electrical mechanism such as magnet latch 510 (FIGS. 5, 7). The smoke system is designed such that, following the use of a fuel container 10, a subsequent fuel container 10 can be inserted in receptacle 22 to start a new smoke cycle. The refilling and use of the smoke system can be before, during, or after the cook.

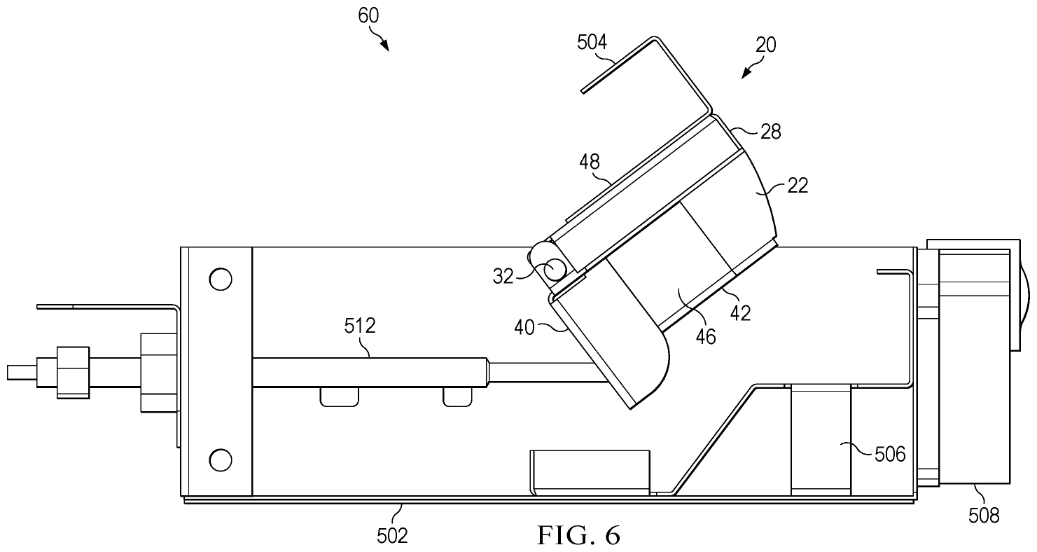

Referring now to FIG. 5 an oblique perspective view of a cold smoke generation system 500 according to aspects of the present disclosure is shown. The smoke generation system 500 may comprise a box or frame 502 which provides a mounting location for other components. In some embodiments, the frame 502 comprises part of a cooking device such as a grill or smoker. As shown, the smoke chamber member 20 is rotated into a lower position (FIG. 5) for smoking. Smoke chamber member 20 may be mounted to the frame 502 at axis 32, e.g., on an axle. Smoke chamber member 20 may be provided with attached handle 504 (FIGS. 5, 6) for opening and closing smoke chamber member 20 for loading operations. An ash tray 506 may be provided for catching ashes from the receptacle 22 of smoke chamber member 20. The ash tray 506 can also contain a fixed or removable filter element to reduce or eliminate ash particle egress.

An ignitor 512 can be seen to fit into the ignitor slot 30 when smoke chamber member 20 is rotated into the operational position as shown in FIG. 5. The ignitor 512 may be an electrical ignitor and contact and/or puncture the fuel container 10 to start smoking operations.

A fan 508 may provide combustion air to the smoke chamber receptacle 22 by creating a vacuum that pulls air into the air flow openings 26. The fan 508 may have a fixed speed, or a variable speed to dynamically adjust the air flow rate allowing further control over the rate and intensity of smoke generation. In other embodiments, cold smoke system 500 could use a variable or single speed fan 508 with or without dynamic control of baffles or flaps to control the air flow. Cold smoke system 500 may be controlled and/or powered through a control circuit of a grill or other cooking device into which it is installed. In other embodiments, it may be controlled by an on-device control circuit. Cold smoke system 500 may be powered through the cooking device into which it is installed and/or from a dedicated power supply. It may be battery or DC powered, or AC powered as from a wall outlet.

Opening and closing of the smoke chamber member 20 can be assisted using a magnetic push-pull latch system e.g., utilizing magnetic latch 510. Opening and closing may be unassisted (e.g., relying on the handle 504 alone). The magnetic latch 510 may interact with the smoke chamber member 20 via the rear wall 40. In some embodiments the smoke chamber member 20 is completely removeable.

A limit switch 514 (FIG. 5) can be used to improve the safety and performance of the system. The limit switch 514 may selectively contact the rear wall 40 of the smoker chamber member 20. Alternatively, other safety mechanisms, such as optical sensors (RF, IR, Visual range, microwave, etc.), magnetic sensors, and mechanical sensors can be used to ensure safe operations of the system.

FIG. 6 is a side cross sectional view of cold smoke generation system 600 according to aspects of the present disclosure. Cold smoke generation system 600 is substantially similar to cold smoke system 500 but utilizes only the handle 504 for loading and unloading operations (e.g., it has no magnetic latch). Smoke chamber member 20 is shown rotated upward for loading/unloading.

FIG. 7 is a side cross sectional view of cold smoke system 700 according to aspects of the present disclosure. Cold smoke generation system 700 is substantially similar to cold smoke system 500 but utilizes magnetic latch 510 for loading an unloading operations (e.g., it has no handle). The smoke chamber member 20 is once again shown rotated upward for loading/unloading).

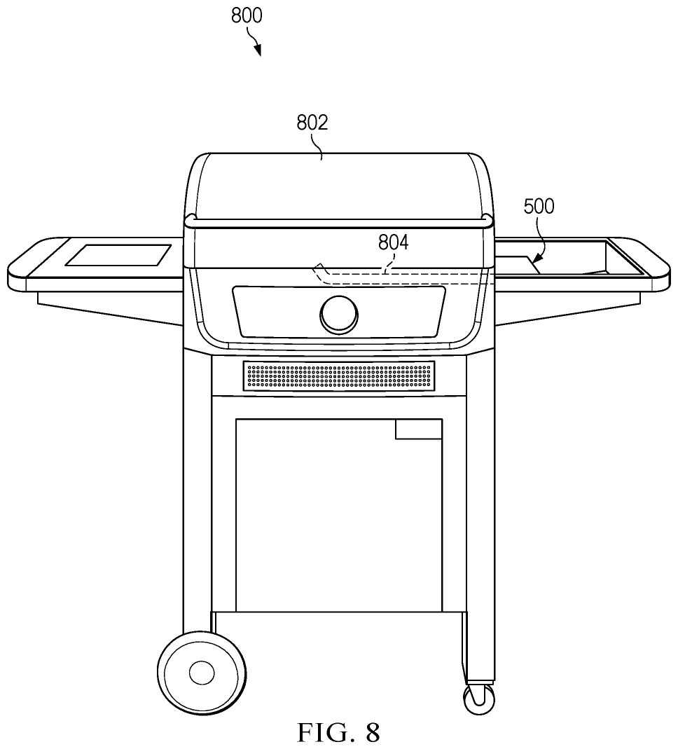

Referring now to FIG. 8, a front perspective, partially transparent view of a cooking device 800 incorporating cold smoke system 500 of the present disclosure and having a single zone smoke output 804. Cooking device 800 may comprise a gas or electric grill, with all appropriate components as known to the art. Cooking device 800 incorporates cold smoke system 500 having single zone smoke output 804 to deliver smoke to a cooking chamber 802, which may also be heated by one or more gas burners of grill or cooking device 800. Output of smoke may be based entirely on operation of cold smoke system 500 or by additional valves, baffles, and air control mechanisms.

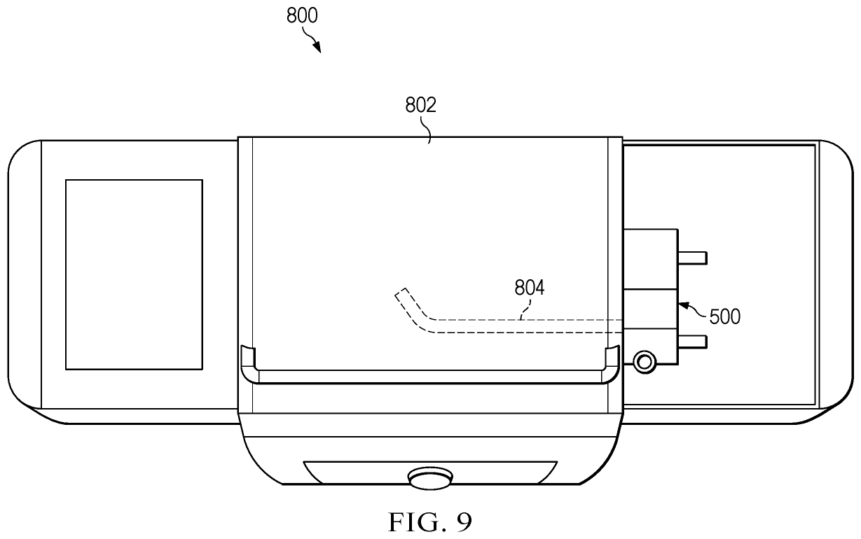

While cooking device 800 may be a gas or electric grill, it should be understood that the configuration is only exemplary, and cold smoke system 500 may be utilized with a wide variety of cooking implements. FIG. 9 provides an overhead, partially transparent view of cooking device 800 showing that, in some embodiments, the single smoke output 804 directs smoke more or less to the center of cooking chamber 802. Single smoke output 804 may be above, below, or on substantially the same vertical level as any internal grate or grates. Additionally, single smoke output 804 may inject smoke into the cooking chamber at a particular angle, which may be adjustable based on movement of deflectors, vanes, grates, or other components.

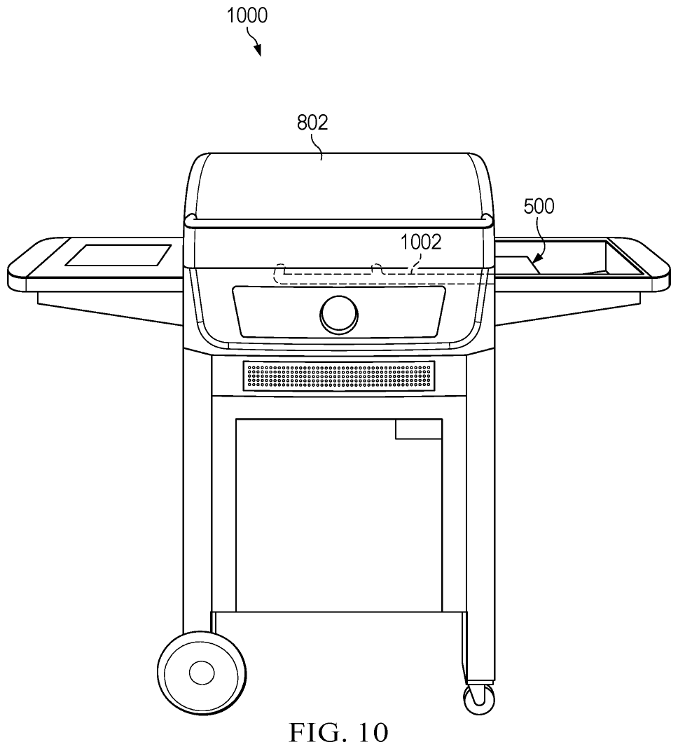

FIG. 10 is a front perspective, partially transparent view of cooking device 1000 incorporating cold smoke system 500 of the present disclosure and having a dual zone smoke output 1002. The cooking device 1000 may comprise a gas or electric grill, with all appropriate components as known to the art. Cooking device 1000 incorporates cold smoke system 500 having dual zone smoke output 1002 to deliver smoke to multiple location within cooking chamber 802, which may also be heated by one or more gas burners or electric heating elements of grill or cooking device 1000. Output of smoke may be based entirely on operation of cold smoke system 500 or by additional valves, baffles, and air control mechanisms.

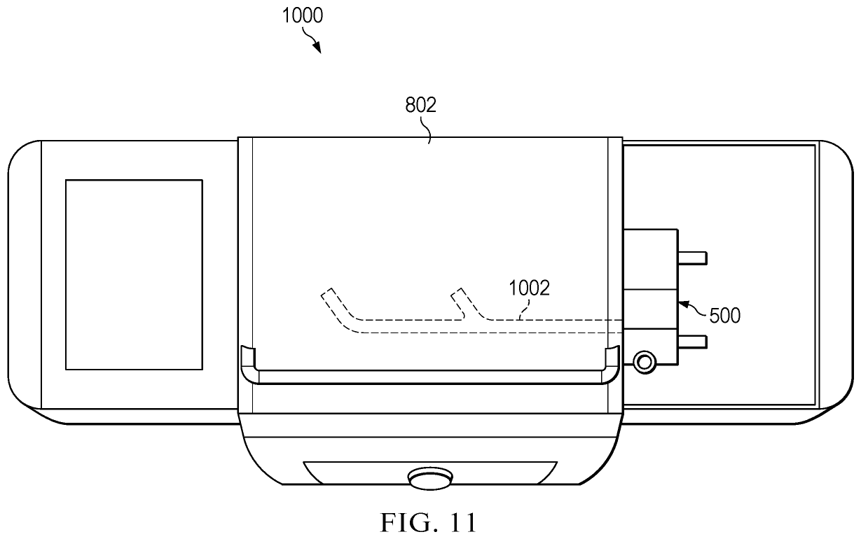

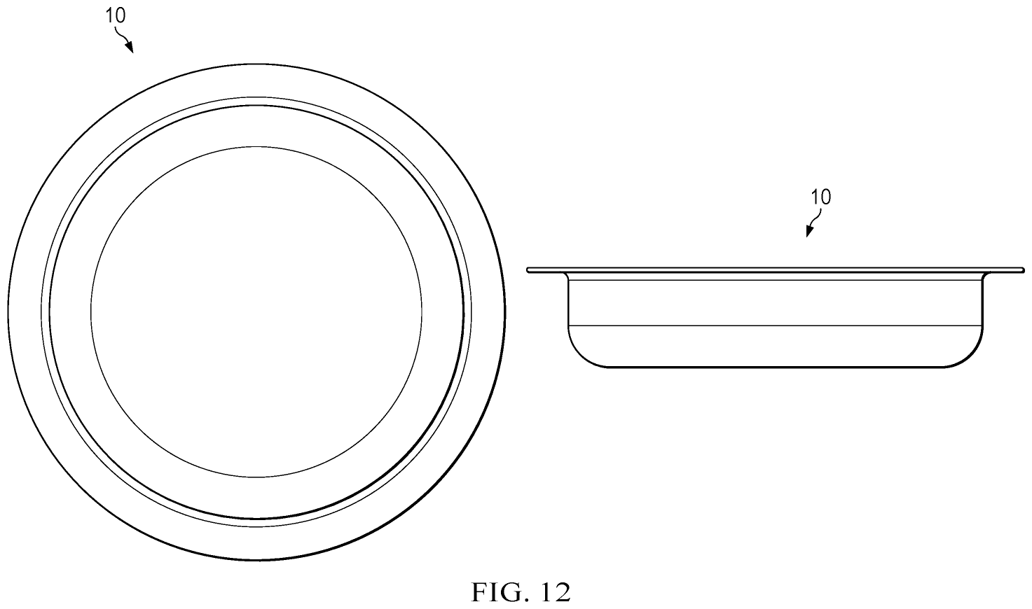

While cooking device 1000 may be a gas or electric grill, it should be understood that the configuration is only exemplary, and cold smoke system 500 may be utilized with a wide variety of cooking implements. FIG. 11 provides an overhead, partially transparent view of cooking device 1000 showing that, in some embodiments, the dual zone smoke output 1002 directs smoke more or less to the center of cooking chamber 802. Dual zone spoke output 1002 may be above, below, or on substantially the same vertical level as any internal grate or grates.

Dual zone smoke output 1002 may inject smoke into cooking chamber 802 at a particular angle, which may be adjustable based on movement of deflectors, vanes, grates, or other components. As dual zone smoke output 1002 is a dual zone output, multiple simultaneous locations and angles of smoke can be provided. Additionally, zones may be individually activated based on dampers, valves, and other flow control mechanisms. It should also be understood that more than two zones of output can be provided and individually controlled where the size of cooking device 1000 and/or desired cooking operations warrant.

An example of the above design is a round shaped pod/pouch/container 10. FIG. 12 shows such a design.

Alternatively, the design may be a container 10 in the form of a triangular pouch where a heat source e.g., ignitor 512 is adjacent to one of its vertices and smoldering travels toward the base. FIG. 2 shows such a design.

Alternatively, to house the pod/container 10 with a variable cross-section, a variable cross-section smoke receptacle 22 is also needed. FIGS. 2-4 show an example of such a cross-section smoke chamber receptacle 22.

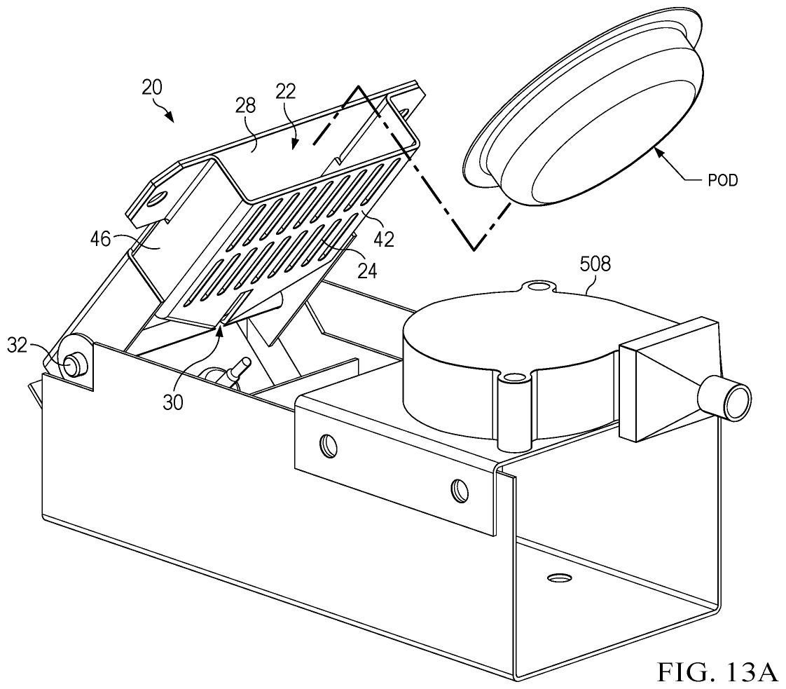

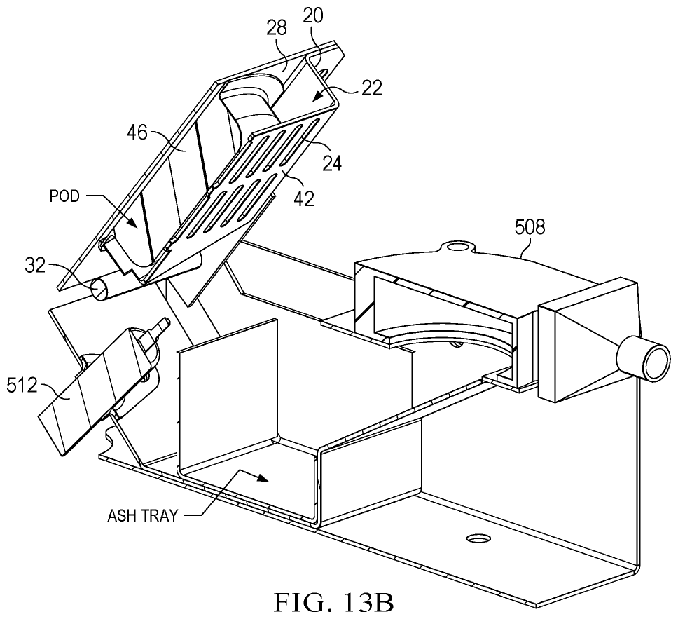

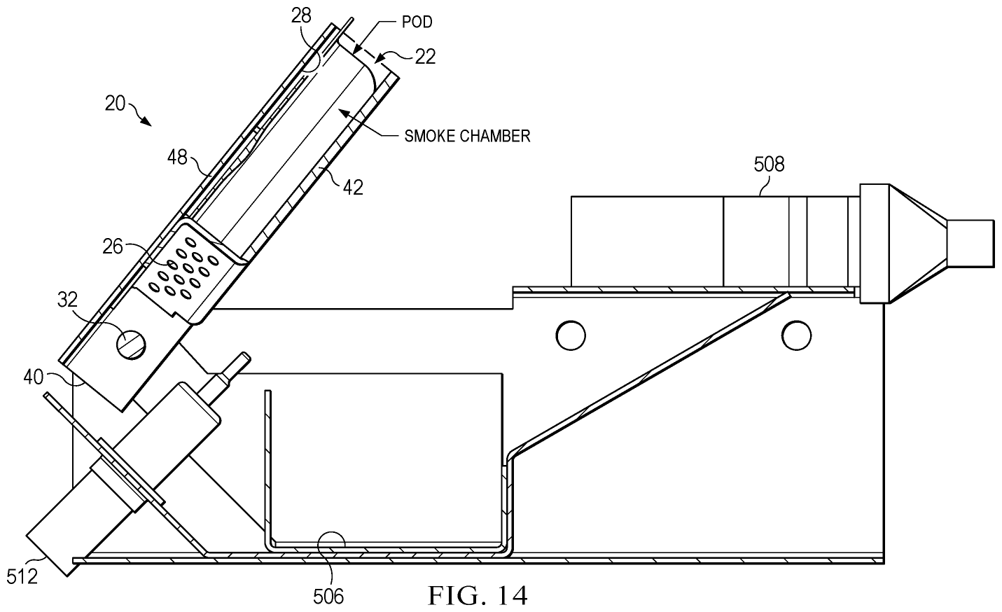

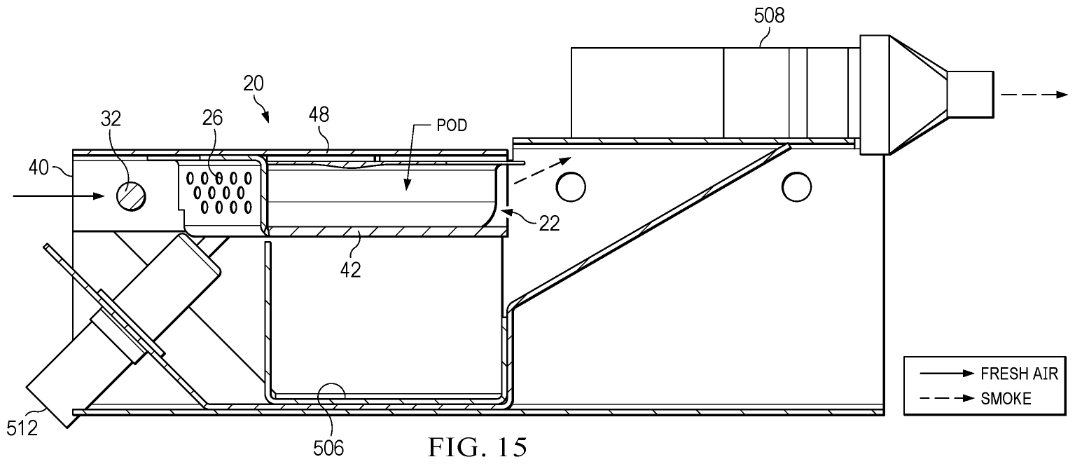

The smoke chamber member 20 can be moveable such as seen in FIGS. 2-7, 13A-15 which utilizes a smoke chamber member 20 rotating about an axis 32, e.g., on an axle.

Alternatively, the smoke chamber member 20 can be movable in other fashions such as sliding vertically or horizontally, whether assisted by some mechanical or electrical mechanism or not. Also, smoke chamber member 20 could be completely removable.

The smoke system is designed such that, following the use of a pod/pouch/container 10, a subsequent pod/pouch/container 10 can be inserted to start a new smoke cycle. The refilling and use of the smoke system can be before, during, or after the cooking. An example of a rotating smoke chamber member 10 allowing the refilling of the smoke system can be seen in FIGS. 5-7, 13A-15.

The movement of the smoke chamber member 10 can be assisted, such as using a magnetic push-pull latch system, e.g., via magnetic latch 510 or unassisted, such as when a solely user operated handle is used such as handle 504.

The ignitor 512 and fans 508 in the smoke system, such as seen in the example of FIGS. 5-7, 13A-15, allow self-ignition (not user light) and dynamic control of the air flow via the fan 508.

The fan 508 controls the air supply for smoldering the wood shavings/chips in fuel container 10. Fan 508 can have a fixed speed or a variable speed to dynamically adjust the air flow rate to control the rate and intensity of the smoke generation.

Alternatively, the system could use a variable or single speed fan 508 with or without dynamic control of baffles or flaps to control the air flow.

The smoke system can be controlled and powered through the main grill control circuit or through an on-device control circuit and powered either through the main grill control circuit, from a battery/DC power-based system, or from the AC from the wall.

A limit switch 514, such as in FIG. 5, can be used to improve the safety and performance of the system by shutting off the fan 508 and/or ignitor 512 to prevent accidental heat or smoke leakage from the system.

Alternatively, other safety mechanisms, such as optical sensors (RF, IR, Visual range, microwave, etc.), magnetic sensors, and mechanical sensors can be used to ensure safe operations of the system.

The smoke system can also have an ash collection system, e.g., ash tray 506 to be able remove the ash following the smoke cycle.

The smoke system can also have a fixed or removable filter system to remove particulates from the air.

The system of the invention may comprise the following features.
1. A smoke chamber defining a receptacle accepting a fuel container having an increasing cross-sectional area in the direction of a combustion air flow through the receptacle;
2. The features of paragraph numbered 1, above, and a fan inducing flow of combustion air through the receptacle;
3. The features of any of paragraphs numbered 1 and 2, above, wherein the smoke chamber defines openings in a floor thereof allowing ash to pass through from the receptacle;
4. The features of any of paragraphs 1-3, above, wherein the smoke chamber defines an ignitor slot;
5. The features of any of paragraphs 1-4, above, further comprising a frame to which the smoke chamber is rotatably mounted;
6. The features of any of paragraphs 1-5, above further comprising a handle affixed to the smoke chamber for rotation of the smoke chamber;
7. The features of any of paragraphs 1-6, above, further comprising a magnetic latch that retains and rotates the smoke chamber relative to the frame for loading;
8. The features of any of paragraphs 1-7, above, further comprising an ash receptacle below the smoke chamber;
9. The features of any of paragraphs 1-8, above, further comprising an ignitor fitting into the ignitor slot;
10. The features of any of paragraphs 1-9, above, further comprising a smoke output from the smoke chamber into a cooking chamber of a cooking device;
11. The features of any of paragraphs 1-10, above wherein the smoke output provides multiple smoke outlets into the cooking chamber;
12. The features of any of paragraphs 1-11, above, further comprising a fuel container having an increasing cross sectional area in the direction of combustion air flow through the receptacle when inserted therein.
13. The features of any of paragraphs 1-12, above, wherein the fuel container comprises a cup having a smoke producing fuel therein;
14. The features of any of paragraphs 1-13, above, wherein the cup comprises a combustible material.
15. The features of any of paragraphs 1-14, above, wherein the fuel container substantially is as described herein.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a smoke chamber member defining a receptacle for accepting a fuel container, said smoke chamber member having an increasing cross-sectional area in a direction of a combustion air flow through the receptacle.

2. The system of claim 1, further comprising a fan for inducing flow of combustion air through the receptacle.

3. The system of any of claim 1, wherein the smoke chamber member defines openings in a floor thereof for allowing ash to pass through from the receptacle.

4. The system of claim 1, wherein the smoke chamber member defines an ignitor slot; and
further comprising an ignitor for being received in said ignitor slot.

5. The system of any of claim 1, further comprising a frame to which the smoke chamber member is rotatably mounted.

6. The system of claim 5, further comprising a handle affixed to the smoke chamber member for facilitating manual rotation of the smoke chamber member.

7. The system of claim 5, further comprising a magnetic latch that selectively retains and rotates the smoke chamber member relative to the frame for loading.

8. The system of claim 5, further comprising an ash receptacle below the smoke chamber member.

9. The system of claim 1, further comprising a smoke output from the smoke chamber member into a cooking chamber of a cooking device.

10. The system of claim 9, wherein the smoke output provides multiple smoke outlets into a cooking chamber of a cooking device.

11. The system of claim 1, wherein the fuel container comprises a cup having a smoke producing fuel therein and wherein the cup comprises a combustible material.

12. A cold smoke system comprising:
a frame;
a smoke chamber member mounted to said frame, said smoke chamber member defining a receptacle for receiving a fuel source that is suitable for combustion to produce smoke;
an ignitor for igniting said fuel source when said smoke chamber member is in an operational position, wherein said ignitor defines a heat source;
a fan mounted on said frame, said fan for moving air through said receptacle.

13. The cold smoke system according to claim 12 wherein:
said receptacle is defined, in part, by a floor member, wherein said floor member defines an ignitor slot for receiving said ignitor when said smoke chamber member is in said closed/operational position.

14. The cold smoke system according to claim 12 wherein:
said smoke chamber member defines air flow openings for facilitating air flow through said receptacle.

15. The cold smoke system according to claim 13 wherein:
said floor member defines ash openings for allowing combustion by-products from said fuel source to fall out of said receptacle.

16. The cold smoke system according to claim 12 wherein:
said smoke chamber member is moveable with respect to said frame to an open/loading position and to said operational position.

17. The cold smoke system according claim 16 wherein:
said smoke chamber member is rotationally mounted to said frame.

18. The cold smoke system according to claim 17 wherein:
said smoke chamber member is movable by a magnetic push-pull latch system via a magnetic latch.

19. The cold smoke system according to claim 12 wherein:
said receptacle defines a variable cross-section having an increasing cross-sectional area in a direction of air flow through said receptacle.

20. The cold smoke system according to claim 12 further comprising:
a fuel container for locating in said receptacle of said smoke chamber member, said fuel container containing said fuel source.

21. The cold smoke system according to claim 20 wherein:
said fuel container has a corresponding shape to said receptacle.

22. The cold smoke system according to claim 20 wherein:
said fuel container is constructed of the same material as said fuel source.

23. The cold smoke system according to claim 12 further comprising:
an ash tray located beneath said receptacle of said smoke chamber member when said smoke chamber member is in said operational position.

24. The cold smoke system according to claim 12 further comprising:
an output member for receiving output from said fan for directing smoke into a cooking chamber of a grill.

25. The cold smoke system according to claim 12 further comprising:
a safety mechanism for selectively shutting off said fan and/or said ignitor for preventing accidental heat or smoke leakage.
